(19) United States
(12) Patent Application Publication
(10) Pub. No.: US 2005/0286391 A1
(43) Pub. Date: Dec. 29, 2005

(54) Method and apparatus for focused beam processing of recording media

(76) Inventors: Christopher J. Formato, Brentwood, CA (US); Neil Deeman, Alamo, CA (US)

Correspondence Address: Raghunath S. Minisandram;Seagate Technology LLC, 920 Disc Drive, SV15B1, Scotts Valley, CA, 95066, US

(21) Appl. No.: 10/875,820

(22) Filed: Jun. 23, 2004

(51) Int. Cl. G03C 5/00; C09K 19/00

(52) U.S. Cl. 369/119; 430/321

(57) ABSTRACT

Embodiments of the invention generally provide a light source substrate processing system. In one embodiment, the present invention provides a spindle motor coupled to a substrate support member. A light source assembly is supported above a substrate disposed on the substrate support member. In another embodiment, the light source assembly includes a movable optical assembly disposed between a pair of light sources and the substrate support member to focus a pair of light beams onto a portion of the substrate surface. Each of the light beams has a different wavelength. The optical assembly includes a plurality of lenses configured to adjust the focal plane of each light beam such that their focal points about converge on a substrate surface location. The focal points of the two light beams about coincide with various movements of at least a portion of the optical assembly. In one embodiment of the present invention, a focus correction assembly is configured to adjust the focal plane of at least one of the light beams in response to temperature fluctuations to maintain the focal points of the two light beams within a desired range of focal points disposed relative a surface of a substrate being processed.

### BACKGROUND OF THE INVENTION

1. Field of the Invention

The invention relates generally to processing recording media substrates with optical media processing systems. More particularly, the present invention relates to applying light beams to optical recording surfaces to write patterns thereon.

2. Description of the Related Art

Generally, in optical media recording systems, a narrowly converged light beam is applied to target positions on substrates, e.g., optical media, to form patterns thereon. Optical media recording systems generally include a light source assembly which includes a pair of light sources. A first light source, such as a laser light source, having a relatively small wavelength is used to write patterns on the substrate surface. Such a narrow wavelength light source may be referred to as the writing light source. A second light source, such as a laser or infrared light source, having a greater wavelength than the writing light source is used to maintain the focus of the writing light source on the surface of the substrate being processed. Such a greater wavelength light source may be referred to as the focusing light source. The advantage to having two different light sources is that it makes it possible to optimize the wavelengths for the required writing or focusing function. In addition, when writing on substrates having a photo-resist thereon, it is possible to select a wavelength for the focusing light source to which the photo-resist is insensitive. During processing, light source substrate processing systems write a desired pattern on a substrate by focusing and modulating the writing light source on a substrate surface such that only specified areas of the substrate are processed.

In one type of light source substrate processing system, the substrate is mounted on a rotating spindle assembly. The rotating spindle assembly is coupled to a spindle motor that provides rotational speed to the spindle and therefore the specimen substrate. The rotational velocity and acceleration of the spindle is generally controlled by a controller in communication with the spindle motor. The light source assembly is usually configured to move in a radial direction relative the rotating axis of the substrate to allow the two light sources to be precisely positioned on desired locations of the rotating substrate surface. As the substrate is rotated, the two light sources are positioned as needed and their beams directed onto the desired regions of the substrate using a modulation control.

During substrate processing, the writing and focusing light sources direct their beams at the surface of the rotating substrate being processed through an optical focusing system. The optical focusing system includes series of lenses and mirrors used to direct the two light sources into a common light path where both light sources are directed to their intended focal point through a common set of lenses. To adjust the focal point for each light source, a portion of the focusing light source is reflected to a detector configured to discern focus of the focus light source. The detector feeds error signals to an optical assembly controller. The optical assembly controller moves the common set of lenses in response to the error signals to adjust the position of the common set of lenses thereby adjusting the focus of both the focusing light source and the writing light source.

Conventionally, as each light source has a different wavelength, portions of the independent light paths for each light source are configured with different lenses. Since the two light sources have different wavelengths, the focal distances of the common set of lenses are different at these wavelengths. When the set of common lenses are moved with respect to the focusing light source, the position of the common lenses to the writing light source changes. Generally, such a focusing issue has been resolved by using a corrective set of focusing lenses positioned between the common set of lenses and the focusing light source and moved jointly therewith. Unfortunately, such an arrangement requires that the distances between the common set of lenses and the corrective set of lenses is stable over fluctuations in temperature. Temperature changes cause expansion and contraction of the structures used to hold the common lenses as well as the corrective lenses. Therefore, structural temperature changes cause variations in focal point of each light source. Variations in focal point of the writing beam may lead to incorrectly written patterns, which may lead to erroneous data and therefore could ultimately lead to inefficiencies in substrate processing throughput.

Therefore, a need exists for a method and apparatus to minimize focusing errors between the focusing light source and the writing light source during substrate processing to maintain a desired focus of the writing light source on the substrate surface.

### SUMMARY OF THE INVENTION

An embodiment of the invention is a light source substrate processing apparatus. The light source substrate processing apparatus includes a spindle motor assembly. A spindle shaft extends from the spindle motor assembly. A substrate support member is mounted to an end of the spindle shaft distal the spindle motor assembly to support the substrate thereon for processing. The light source substrate processing apparatus includes a light source assembly that provides a writing light beam and focus light beam in optical communication with at least a portion of a surface of the substrate. The light source assembly being configured to adjust the focus of the writing light beam onto a portion of a surface of the substrate. A controller is provided in communication with at least some portion of the substrate processing system. The controller is configured to provide focus correction data to the light source assembly to adjust one or more focal points of the writing light beam associated with temperature changes detected by the controller.

An embodiment of the invention is a method of processing substrates with a light source processing system. The method includes focusing a writing light beam onto a surface of the substrate and measuring changes in temperature of at least some portion of the light processing system which impacts focusing of the writing light beam. The method further includes maintaining a focal point of the writing light beam within a desired distance range proximate the surface of the substrate being processed by adjusting the focus of the writing light beam in response to at least some of the temperature changes measured.

An embodiment of the invention is a system for processing a substrate with light beams. The system includes writing light beam means for writing a pattern on a surface of the substrate, focusing means for focusing the writing light beam means onto the substrate surface, and focus adjusting means for adjusting at least one focal point of the writing light beam means in response to temperature changes of at least some portion of the system.

### BRIEF DESCRIPTION OF THE DRAWINGS

So that the manner in which the above recited embodiments of the invention are attained and can be understood in detail, a more particular description of the invention, briefly summarized above, may be had by reference to the embodiments thereof which are illustrated in the appended drawings. The appended drawings illustrate only typical embodiments of this invention and are therefore not to be considered limiting of its scope, for the invention may admit to other equally effective embodiments.

FIG. 1 is a high-level side-view illustration of one embodiment of a light source substrate processing system in accordance with embodiments of the invention.

FIG. 2 is a high-level front view illustration of one embodiment of the light source substrate processing system of FIG. 1 in accordance with embodiments of the invention.

FIG. 3 is a high-level schematic illustration of one embodiment of a beam focusing assembly of the light source substrate processing system of FIG. 1 in accordance with embodiments of the invention.

FIG. 4 is a high-level schematic of one embodiment of a controller of the light source substrate processing system of FIG. 1 in accordance with embodiments of the invention.

FIG. 5 is flowchart illustrating a method for controlling light beam focusing of the light source substrate processing system of FIG. 1 in accordance with embodiments of the invention.

### DETAILED DESCRIPTION OF THE PREFERRED EMBODIMENTS

In the following description, numerous specific details are set forth to provide a more thorough understanding of the present invention. However, it will be apparent to one of skill in the art that the present invention may be practiced without one or more of these specific details. In other instances, well-known features have not been described in order to avoid obscuring the present invention.

As will be described below, embodiments of the present invention pertain to specific method steps implementable on computer systems. In one embodiment, the invention may be implemented as a computer program-product for use with a computer system. The programs defining the functions of at least one embodiment can be provided to a computer via a variety of computer-readable media (i.e., signal-bearing medium), which include but are not limited to, (i) information permanently stored on non-writable storage media (e.g. read-only memory devices within a computer such as read only CD-ROM disks readable by a CD-ROM or DVD drive; (ii) alterable information stored on a writable storage media (e.g. floppy disks within diskette drive or hard-disk drive); or (iii) information conveyed to a computer by communications medium, such as through a computer or telephone network, including wireless communication. The latter specifically includes information conveyed via the Internet. Such signal-bearing media, when carrying computer-readable instructions that direct the functions of the invention, represent alternative embodiments of the invention. It may also be noted that portions of the product program may be developed and implemented independently, but when combined together are embodiments of the invention.

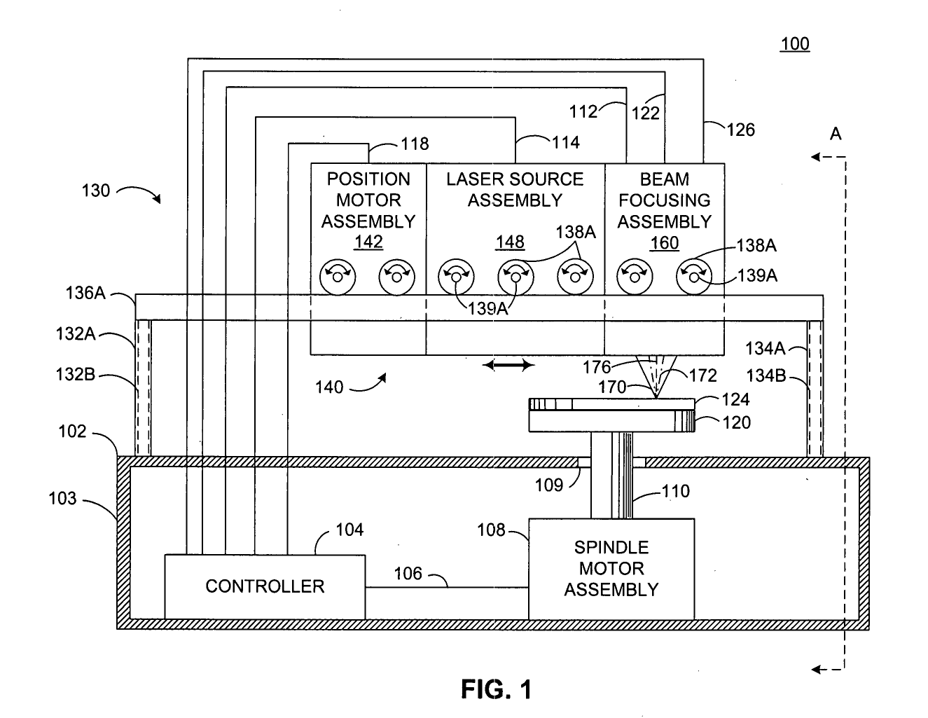

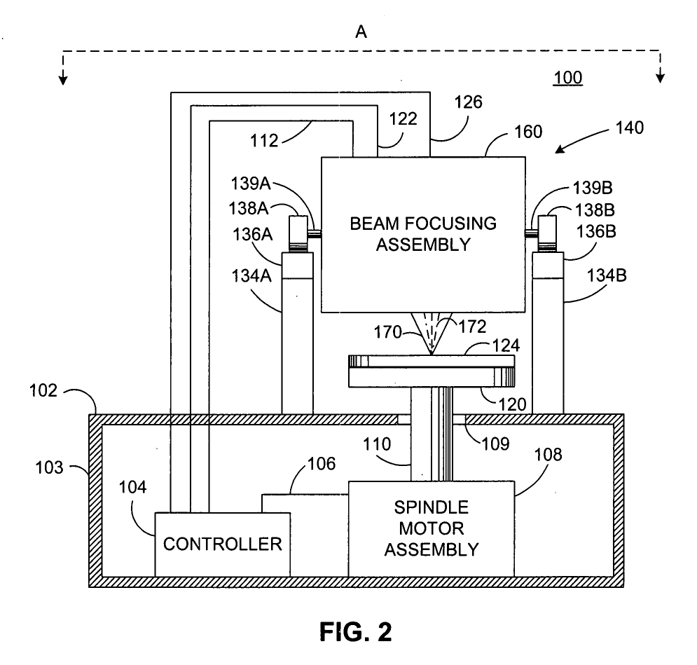

FIG. 1 is a high-level side-view illustration of one embodiment of a light source substrate processing system 100 in accordance with embodiments of the invention. FIG. 2 is a high-level front view illustration of one embodiment of the light source substrate processing system 100 of FIG. 1 in accordance with embodiments of the invention. Light source substrate processing system 100 includes process control assembly 102 and processing assembly 130 disposed thereon configured to process substrates 124 such as optical recording media, silicon substrates, and the like with light beams. Process control assembly 102 includes frame 103 configured to support substrate processing functions described herein. Frame 103 may be formed from a plurality of materials such as metal, plastic, and the like, configured to support processing assembly 130 thereon. In one embodiment of the present invention, process control assembly 102 includes controller 104 described further below. Process control assembly 102 includes spindle motor assembly 108 having spindle shaft 110 extending therefrom. Spindle shaft 110 extends from spindle motor assembly 108 through sidewall opening 109 of process control assembly 102. Spindle shaft 110 is coupled on an end distal spindle motor assembly 108 to substrate support member 120. Spindle motor assembly 108 may be configured to rotate spindle shaft 110 and therefore rotate substrate support member 120 therewith. In one embodiment, spindle motor assembly 108 is in communication with controller 104 via control signal 106 for control thereof as is known. During substrate processing, substrate 124 is disposed upon an upper surface of substrate support member 120. Substrate support member 120 may be of virtually any type of substrate support such as an electronic chuck, clamp, and the like, adapted to support substrate 124 thereon for processing.

Processing assembly 130 includes light source assembly 140 moveably supported on rail member 136A and rail member 136B. Vertical support members 132A and 132B and vertical support members 134A and 134B each support an end of respective rail members 136A and 136B. For example, vertical support member 132A supports one end of rail member 136A. Vertical support member 134A supports another end of rail member 136A. Vertical support member 132B supports one end of a rail member 136B. Vertical support member 134B supports another end of rail member 136B (See FIG. 2). In one embodiment, respective rail members 136A and rail members 136B are positioned in an about horizontal position relative substrate support member 120 and substrate 124 supported thereon.

In one embodiment, light source assembly 140 may be supported by a plurality of transport wheels 138A and transport wheels 138B, wherein each transport wheel 138A, 138B are in rotating contact with a respective rail member 136A and 136B. Transport wheels 138A and 138B are rotationally coupled to light source assembly 140 via respective shaft 139A and shaft 139B. For purpose of clarity, light source assembly 140 is described as supported by transport wheels 138A and transport wheels 138B. It is understood however that light source assembly 140 may be supported by virtually any type of moveable transport system such as bearings, gears, and the like configured to allow light source assembly 140 to be moveably positioned with respect to substrate 124 for processing thereof. While light source substrate processing system 100 is described having a movable light source assembly 140, it is contemplated that light source assembly 140 may be fixed and spindle motor assembly 108 may be movable to position substrate 124 for processing.

In one embodiment of the present invention, light source assembly 140 includes position motor assembly 142, laser source assembly 148, and beam focusing assembly 160. Position motor assembly 142 may be configured to rotate one or more transport wheels 138A and transport wheels 138B (see FIG. 2) to moveably position light source assembly 140 with respect to substrate 124 for processing thereof. Position motor assembly 142 may be configured from at least one type of motor assembly adapted to impart motion to light source assembly 140. For example, position motor assembly 142 may be an electric motor configured to rotate one or more transport wheels 138A and transport wheels 138B in response to one or more controller 104 position control signals transmitted via control signal 118.

In one configuration, light source substrate processing system 100 may be configured in a radial translation configuration such that substrate 124 and light source assembly 140 are positioned in a radial manner relative one another using any number of recording positioning methodologies such as R-theta and XY translation, for example. Such a radial translation system configurations may be used to, for example, record concentric, spiral patterns, and the like on substrate 124. In such radial translation configurations, light source assembly 140 may be configured to move in a radial pattern relative the axis of a rotating, or non-rotating substrate 124. Alternatively, light source substrate processing system 100 may be configured such that substrate 124 may be moved in a radial pattern relative light source assembly 140.

Laser source assembly 148 may include a variety of light sources such as lasers and supporting optics as known in the art to supply light to beam focusing assembly 160. For example, laser source assembly 148 may include two or more types of light sources some of which are described herein, wherein one light source may be used to provide writing beam 170 to a surface of a substrate 124, while another light source may be used to provide focus beam 172 for focus control of writing beam 170. In one configuration, writing beam 170 and focus beam 172 are derived from laser sources having a wavelength of less than about 500 nm and greater than about 500 nm, respectively. In such a configuration, writing beam 170 wavelength is selected to process a surface photo-resist whereas focus beam 172 wavelength is selected to about not process the photo-resist. For example, writing beam 170 may have a wavelength of about 257 nm, while focus beam 172 may have a wavelength of about 650 nm. While focus beam 172 is described herein in terms of coherent light such as lasers, it is contemplated that focus beam 172 may include other types of coherent and non-coherent light sources in wavelengths that may be used to advantage such as infrared light. In one embodiment, laser source assembly 148 may be configured without some or all internal light sources and therefore process light received from external light sources (not shown). For example, laser source assembly 148 may include a variety of mirrors and optics configured to receive and process external light beams, such as lasers, and direct such external light beams to beam focusing assembly 160. Controller 104 may control at least some operations of laser source assembly 148, such as laser beam intensity, modulation, etc. via control signal 114 as described herein.

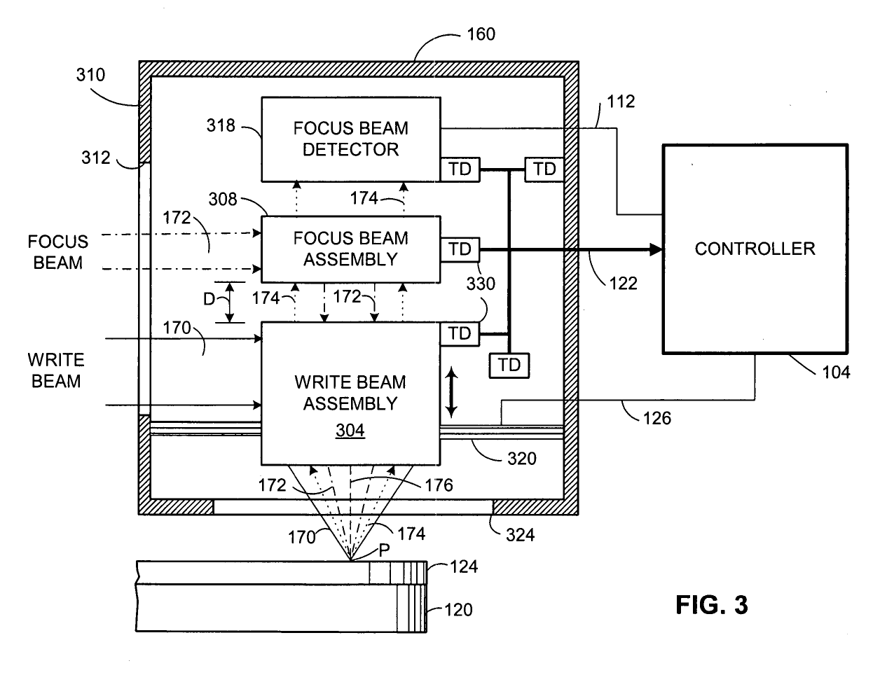

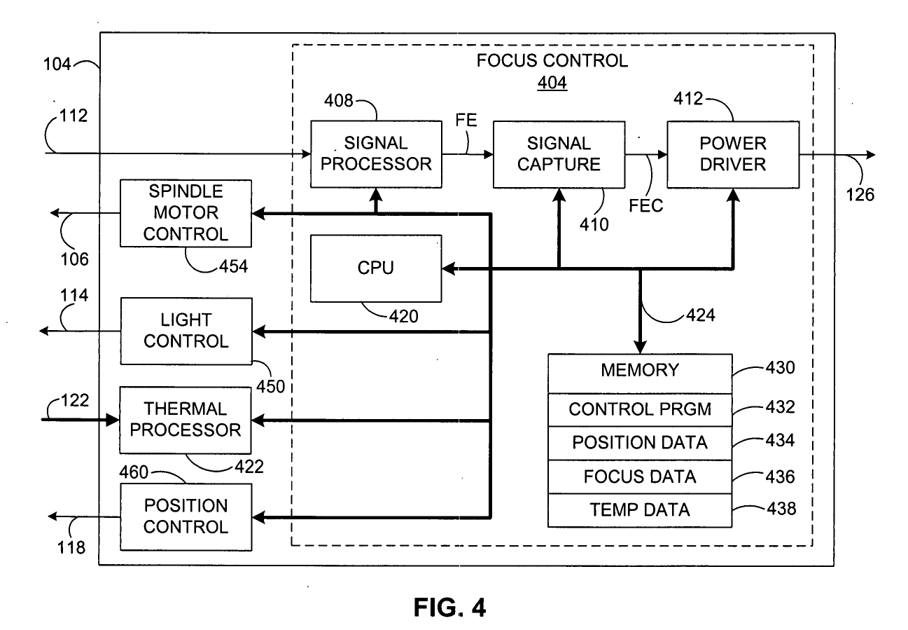

Beam focusing assembly 160 may be configured to receive and focus beams of light received from laser source assembly 148 onto one or more surfaces of substrate 124. Beam focusing assembly 160 may be electrically coupled to controller 104 via focus signal 112, temperature signals 122, and focus control signal 126 described below with reference to FIG. 3 and FIG. 4. In one configuration, beam focusing assembly 160 focuses two beams of light onto a surface of substrate 124 for processing thereof. For example, beam focusing assembly 160 may receive and focus two types of light beams from laser source assembly 148 some of which are described herein, wherein one light source may be used to provide writing beam 170 to a surface of a substrate 124, while another light source may be used to provide focus beam 172 described herein.

FIG. 3 is a high-level schematic illustration of one embodiment of a beam focusing assembly 160 of the light source substrate processing system 100 of FIG. 1 in accordance with embodiments of the invention. Beam focusing assembly 160 includes enclosure 310 configured to support optical components and assemblies described herein to advantage. Enclosure 310 may be formed from a plurality of materials such as metal, plastic and the like. Enclosure 310 includes at least one opening 312 configured to allow light beams to pass therethrough. Opening 312 may include glass and other optically clear materials configured to allow light beams to pass therethrough. Enclosure 310 includes opening 324 configured to allow light beams to pass therethrough. Opening 324 may include glass and other optically clear materials configured to allow light beams to pass therethrough. Opening 324 may be positioned relative substrate 124 to allow light beams, such as focus beam 172 and light beam 174, to be focused to a common focal point P on a surface of substrate 124.

Beam focusing assembly 160 includes write beam assembly 304, focus beam assembly 308, and focus beam detector 318. Write beam assembly 304 is configured to receive and focus writing beam 170 on one or more surface targets of substrate 124. In one embodiment, write beam assembly 304 receives writing beam 170 from light source assembly 140 via opening 312 and directs writing beam 170 via opening 324 focused to a common focal point P onto a surface of substrate 124. Write beam assembly 304 includes a plurality of optics and mirrors configured to focus writing beam 170 onto a substrate surface. For example, write beam assembly 304 may include a series of optics as are known in the art to focus writing beam 170 on to a surface of substrate 124. Write beam assembly 304 is mechanically positioned by position coil 320. Position coil 320 adjusts the distance of write beam assembly 304 along optical axis 176 relative a light source (not shown) emitting writing beam 170, to focus writing beam 170 onto substrate 124. In one embodiment, position coil 320 is activated by controller 104 to move write beam assembly 304 in a vertical direction relative substrate 124 to focus writing beam 170 thereon.

Focus beam assembly 308 is configured to receive and direct focus beam 172 into write beam assembly 304 for focusing thereof to a common focal point P on the substrate surface. In one embodiment, focus beam assembly 308 receives focus beam 172 from light source assembly 140 via opening 312 and directs focus beam 172 through write beam assembly 304 onto a surface of substrate 124 via opening 324. Focus beam assembly 308 and write beam assembly 304 may be configured to move as a single assembly. As focus beam 172 has a different wavelength than writing beam 170, focus beam assembly 308 may include one or more sets of optics, such as error correction lenses, to pre-adjust the focus of focus beam 172 such that focus beam 172 and writing beam 170 may be focused to a common focal point P on the substrate surface.

In one configuration, write beam assembly 304 defines a common optical path for focus beam 172 and writing beam 170 such that movement of write beam assembly 304 changes a common focal point P for both writing beam 170 and focus beam 172. Focus beam assembly 308 is configured to direct focus beam 172 into such a common optical path of write beam assembly 304. In one embodiment, writing beam 170 and focus beam 172 may be directed along a common optical axis 176 from write beam assembly 304 to a common focal point P on a surface of substrate 124. A reflected beam 174 of focus beam 172 is reflected from a surface of substrate 124 along optical axis 176. Such a reflected beam 174 passes through write beam assembly 304 and focus beam assembly 308 to focus beam detector 318. While writing beam 170 and focus beam 172 are described in terms of being directed along optical axis 176, it is contemplated that in another embodiment, focus beam 172 may be provided along another axis offset from optical axis 176. For example, focus beam 172 may exit from write beam assembly 304 at an offset angle relative optical axis 176, reflect off a surface of substrate 124, such as common focal point P, and reenter write beam assembly 304 at an offset angle. Write beam assembly 304 may be configured so that such a reflected portion of such offset focus beam 172 may be directed though write beam assembly 304 and focus beam assembly 308 to focus beam detector 318 for processing thereof.

Focus beam detector 318 may be configured to determine from reflected beam 174 if focus beam 172 is focused on a substrate surface at common focal point P. In one embodiment, focus beam detector 318 uses a series of detection diodes (not shown) aligned in a pattern as known to determine the vertical position of common focal point P relative the surface of the substrate 124. For example, depending on changes in thickness or flatness of substrate 124 while substrate 124 is moving, e.g., rotating, radially translating, etc., relative beam focusing assembly 160, common focal point P may be positioned about above, on, or below the surface of substrate 124. In one operational example, if a distance changes occurs during substrate processing between the substrate surface and common focal point P on the substrate surface, focus beam detector 318 provides focus signal 112 indicative thereof to controller 104. Controller 104 processes such focus signal 112 and provides focus control signal 126 to position coil 320 in response thereto. In a focus correction process, position coil 320 mechanically adjusts write beam assembly 304 along optical axis 176 to refocus focus beam 172 onto the surface of the substrate 124 within a desired focal point range. Since focus beam 172 and writing beam 170 follow a common optical path through write beam assembly 304, adjusting focus beam 172 to maintain common focal point P on substrate surface also adjusts the focus of writing beam 170.

In one embodiment to detect temperature variations, light source substrate processing system 100 includes at least one temperature detector 330 disposed in contact with, or in proximity thereto. Temperature detector 330 may be of virtually any type of temperature detector 330 and temperature detection system such as thermocouples, thermometers, resistance temperature devices, infrared radiation detection devices, and the like, configured to measure temperature. For example, with reference to beam focusing assembly 160, one or more temperature detectors 330 may be placed in one or more locations proximate focus beam assembly 308 and write beam assembly 304 to detect temperature variations thereof affecting the focus of writing beam 170 and focus beam 172. Temperature detectors 330 may be configured to output temperature measurements as one or more temperature signals 122 to controller 104 for processing thereof.

In one embodiment of the present invention, a plurality of temperature detectors 330 are placed within and in contact with enclosure 310 for increased temperature detection resolution. In one operational example, controller 104 processes temperature changes detected to correct for changes in focal points, e.g., common focal point P, for writing beam 170 and focus beam 172 over a range of temperatures as described below. Such range of temperatures may be associated with parts of beam focusing assembly 160 that affect the focus of writing beam 170 and focus beam 172. For example, changes in temperature may affect a distance D between focus beam assembly 308 and write beam assembly 304 thereby affecting focal points of writing beam 170 and focusing beam 172.

FIG. 4 is a high-level schematic of one embodiment of a controller 104 of the light source substrate processing system 100 of FIG. 1 in accordance with embodiments of the invention. In one embodiment, controller 104 includes light control circuit 450, thermal data processing circuit 422, position control circuit 460, spindle motor control 454, and focus control circuit 404. Light control circuit 450 may be configured to control one or more light sources, such as lasers, for use with laser source assembly 148 described herein. Thermal data processing circuit 422 is configured to process temperature signals 122. Position control circuit 460 may be configured to control one or more processing positions of light source assembly 140 via control signal 118. Spindle motor control 454 may be configured to control rotation of spindle shaft 110 via control signal 106.

Focus control circuit 404 includes Central Processing Unit (CPU) 420. CPU 420 may be configured to communicate with memory 430, light control circuit 450, position control circuit 460, spindle motor control 454, and thermal data processing circuit 422 via bus 424, for data processing and control thereof. The CPU 420 may be under the control of an operating system that may be disposed in memory 430. Virtually any operating system supporting the configuration functions disclosed herein may be used.

Memory 430 is preferably a random access memory sufficiently large to hold the necessary programming and data structures of the invention. While memory 430 is shown as a single entity, it should be understood that memory 430 may in fact comprise a plurality of modules, and that memory 430 may exist at multiple levels, from high speed registers and caches to lower speed but larger direct random access memory (DRAM) chips.

Illustratively, memory 430 may include a substrate process control program 432 that, when executed on CPU 420, controls at least some operations of light source substrate processing system 100. The substrate process control program 432 may use any one of a number of different programming languages. For example, the program code can be written in PLC code (e.g., ladder logic), a higher-level language such as C, C++, Java, or a number of other languages. While substrate process control program 432 may be a standalone program, it is contemplated that substrate process control program 432 may be combined with other programs.

In one embodiment, memory 430 may include focus data 436. Focus data 436 may be used by controller 104 to control beam focusing assembly 160 to focus writing beam 170 and focus beam 172 on, for example, one or more common focal points P on a surface of substrate 124 as described herein. Focus data 436 may include predetermined focus data based on previous substrate processes, and may be determined from focus signal 112. In another embodiment of the present invention, memory 430 may include position data 434. Position data 434 may be used by controller 104 to horizontally position light source assembly 140 in one or more substrate processing positions using, for example, position control circuit 460. Memory 430 includes temperature data 438 described below. In one embodiment, CPU 420 processing one or more temperature signals 122 from temperature detector 330 may derive such temperature data 438.

Focus control circuit 404 includes signal processing circuit 408, signal capture circuit 410, and power driver circuit 412. Signal processing circuit 408 is configured to provide focus error signal FE to signal capture circuit 410 in response to focus signal 112. In one operational configuration, focus beam detector 318 provides focus signal 112 derived from an array of photo detectors (not shown), wherein at least some of which may be in optical communication with reflected beam 174. Such an output of photo detectors may be connected to signal processing circuit 408 via focus signal 112 for processing thereof. Signal processing circuit 408 outputs FE signal to signal capture circuit 410 in response to focus signal 112. Signal capture circuit 410 processes at least one sample of FE signal to provide a focus error capture (FEC) signal to power driver circuit 412. Signal capture circuit 410 may be configured to sample FE signal, process such FE signal sample, and hold a resultant FEC signal. Such sample and hold technique may provide a dynamic focus loop response to allow focus control circuit 404 to control the focus response of write beam assembly 304 as desired. In one embodiment, FE signal and FEC signal may transmitted by signal processing circuit 408 and signal capture circuit 410, respectively, to memory 430 and CPU 420 via bus 424 for storage and processing thereof.

In one focus loop operational example, when focus beam 172 is out of focus on a desired portion of the substrate being processed, i.e. common focal point P is either above or below a desired point on the substrate surface, focus control circuit 404 controls the focus of focus beam 172 via write beam assembly 304 (See FIG. 3) to correct such focus. For example, signal processing circuit 408 provides FE signal to Signal capture circuit 410. Signal capture circuit provides FEC signal to power driver circuit 412 in response to such FE signal. Power driver circuit 412 provides focus control signal 126 to position coil 320 in response thereto to refocus focus beam 172. Position coil 320 moves write beam assembly 304 along optical axis 176 until focus beam 172 is within a desired focal point focus threshold, e.g., range, of common focal point P. As mentioned above, writing beam 170 is also focused by writing beam assembly 304. Thus, during a focus correction loop operation, focusing focus beam 172 also affects the focus of writing beam 170.

In one embodiment, thermal data processing circuit 422 outputs signals, e.g., digital data, in response to temperature signals 122 to CPU 420 and memory 430 via bus 424 for processing thereof as temperature data 438. CPU 420 associates such temperature data 438 to focusing errors related to focusing writing beam 170 and focus beam 172 within a desired range of a common focal point P. In one configuration, such temperature data 438 is processed by CPU 420 to adjust focus control signal 126 according to temperatures measured. In one embodiment, such temperature data 438 is used to adjust focus positions of write beam assembly 304 such that at different processing temperatures write beam assembly 304 will refocus writing beam 170 and focus beam 172 within a desired range of common focal point P.

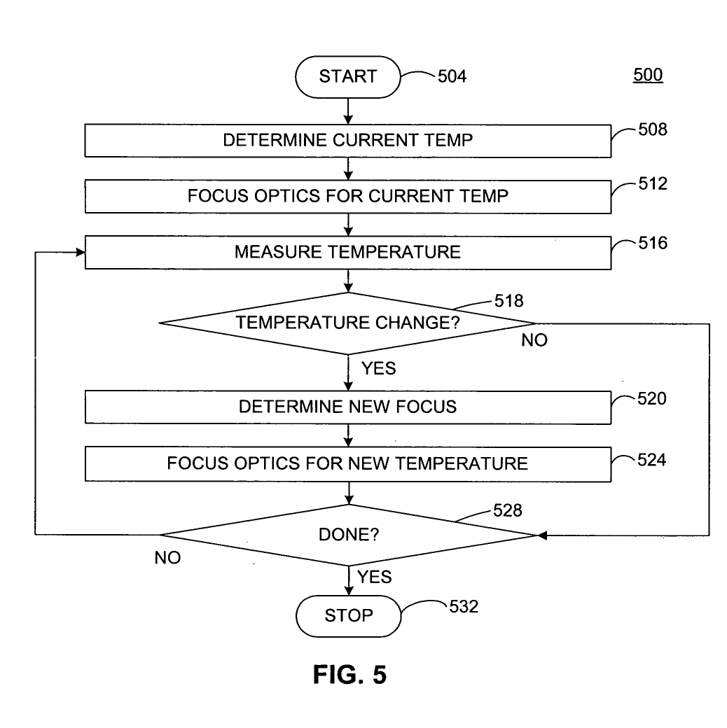

FIG. 5 is a high-level flow diagram of one embodiment of a method 500 of controlling light beam focusing of a light source processing system 100 of FIG. 1 in accordance with embodiments of the invention. Method 500 may be entered into at 504 for example when substrate process control program 432 is activated for processing substrates 124 with light source substrate processing system 100. At 508, at least one base processing temperature is measured. For example, one or more temperature detection devices such as temperature detector 330 may measure one or more base temperatures that affect focusing writing beam 170 and focus beam 172 to a common focal point P. At 512, a writing beam 170 and a focus beam 172 are focused within a desired range of a common focal point P determined at such a base process temperature. Another process temperature is measured at 516. At 518, if a temperature change is detected between such a base temperature and other process temperature, method 500 proceeds to 520 to determine a focus adjustment at such other process temperature. At 524, a writing beam 170 and a focus beam 172 are focused within a desired range of such common focal point P at such other process temperature. If however at 518, such another process temperature is within a desired range of such a base temperature, then method 500 proceeds to 528. At 528, method 500 determines if method 500 is finished. If method 500 is finished then method ends at 532. If however, method is not finished then method 500 returns to 516.

While the foregoing is directed to embodiments of the invention, other and further embodiments of the invention may be devised without departing from the basic scope thereof. The scope of the invention is determined by the claims that follow and equivalents.

1. A light source substrate processing apparatus, comprising:
a spindle motor assembly;
a spindle shaft extending from the spindle motor assembly;
a substrate support member mounted to an end of the spindle shaft distal the spindle motor assembly to support the substrate thereon for processing;
a light source assembly provides a writing light beam and focus light beam in optical communication with at least a portion of a surface of the substrate, the light source assembly being configured to adjust the focus of the writing light beam onto a portion of the substrate; and
a controller in communication with at least some portion of the substrate processing system, the controller is configured to provide focus correction data to the light source assembly to adjust one or more focal points of the writing light beam associated with temperature changes detected by the controller.

2. The apparatus of claim 1, further comprising a processing position assembly configured to move the light source assembly into at least one substrate processing position relative the substrate.

3. The apparatus of claim 1, wherein the writing light beam is a laser beam comprising at least one wavelength configured to process the substrate.

4. The apparatus of claim 3, wherein the wavelength of the laser beam is less than 500 nm.

5. The apparatus of claim 1, wherein the focusing light beam is a laser beam comprising at least one wavelength configured to provide a focusing beam on the substrate surface.

6. The apparatus of claim 5, wherein the wavelength of the laser beam is greater than 500 nm.

7. The apparatus of claim 1, wherein the controller comprises a focus control circuit configured to detect temperature changes of the light source assembly.

8. The apparatus of claim 7, wherein the light source assembly comprises at least one temperature detector thermally coupled thereto to provide temperature data to the focus control circuit.

9. A method of processing at least one substrate with a light processing system, comprising:
focusing a writing light beam onto a surface of the substrate;
measuring changes in temperature of at least some portion of the light processing system; and
maintaining a focal point of the writing light beam within a desired distance range proximate the surface of the substrate being processed by adjusting the focus of the writing light beam in response to at least some of the temperature changes measured.

10. The method of claim 9, wherein the focusing comprises directing at least one focus light beam onto a surface of the substrate and detecting a reflected portion of the at least one focusing light beam.

11. The method of claim 10, wherein detecting the reflected portion of the focusing light beam comprises adjusting from the reflected portion of the focusing light beam the focus of the writing light beam.

12. The method of claim 9, wherein adjusting the focus of the writing light beam comprises adjusting a focusing assembly configured to focus the writing light beam on the substrate surface to be processed.

13. The method of claim 12, wherein measuring the change in temperature comprises determining a change in temperature of the focusing assembly that affects the focus of the writing light beam.

14. The method of claim 13, wherein adjusting the focusing assembly comprises moving the focusing assembly relative a writing light source in response to the measured temperature changes until the focal point of the writing light beam is within the desired distance range proximate the surface of the substrate being processed.

15. A system for processing a substrate with light beams, comprising:
a writing light beam means for writing a pattern on a surface of the substrate;
a focusing means for focusing the writing light beam means onto the substrate surface; and
a focus adjusting means for adjusting at least one focal point of the writing light beam means in response to temperature changes of at least some portion of the system.

16. The system of claim 15, further comprising means to establish at least one processing position between the substrate and the writing light beam means.

17. The system of claim 15, wherein the focusing adjusting means comprises a focusing assembly configured to focus the writing light beam means and a focusing light beam means to within a desired range of a common focal point.

18. The system of claim 17, further comprising a focus control circuit in communication with the focusing assembly, the focus control circuit being configured to control the focusing assembly to position the focal point of the writing light beam means and the focusing light beam means.

19. The system of claim 17, wherein the focusing assembly comprises a temperature detection circuit configured to detect temperature changes in at least a portion of the system that affects the focal point of the writing light beam means.

20. The system of claim 19, wherein the temperature detection circuit comprises at least one temperature detector configured to detect at least some temperature changes of the portion of the system that affects the focal point of the writing light beam means.
